(19) United States
(12) Patent Application Publication
(10) Pub. No.: US 2012/0050949 A1
(43) Pub. Date: Mar. 1, 2012

(54) Lithium ion capacitor and method of manufacturing the same

(75) Inventors: Hak Kwan Kim, Hanam-si (KR); Bae Kyun Kim, Seongnam-si (KR); Dong Hyeok Choi, Suwon-si (KR); Hyun Chul Jung, Yongin-si (KR)

(73) Assignee: SAMSUNG ELECTRO-MECHANICS CO., LTD.

(21) Appl. No.: 13/137,557

(22) Filed: Aug. 25, 2011

(30) Foreign Application Priority Data
Aug. 31, 2010 (KR) 10-2010-0084815

(51) Int. Cl. H01G 9/035; H01G 7/00

(52) U.S. Cl. 361/505; 29/25.41

(57) ABSTRACT

Provided are a lithium ion capacitor and a method of manufacturing the same. The lithium ion capacitor includes an anode current collector, a first anode active material layer disposed on at least one surface of the anode current collector, and a second anode active material layer disposed on the first anode active material layer and formed of a lithium oxide layer having a spinel structure.

### CROSS-REFERENCE TO RELATED APPLICATIONS

This application claims the benefit of Korean Patent Application No. 10-2010-0084815 filed with the Korea Intellectual Property Office on Aug. 31, 2010, the disclosure of which is incorporated herein by reference.

### BACKGROUND OF THE INVENTION

1. Field of the Invention

The present invention relates to a lithium ion capacitor, and more particularly, to a lithium ion capacitor including a lithium oxide layer having a spinel structure on an active material layer formed of a carbon material and a method of manufacturing the same.

2. Description of the Related Art

In general, electrochemical energy storage devices are core parts of finished products, which are essentially used in all mobile information communication devices and electronic devices. In addition, the electrochemical energy storage devices will be used as high quality energy sources in new and renewable energy fields that can be applied to future electric vehicles and mobile electronic devices.

The electrochemical energy storage devices, typically, a lithium ion battery and an electrochemical capacitor, use an electrochemical theory.

Here, the lithium ion battery is an energy device that can be repeatedly charged and discharged using lithium ions, which has been researched as an important power source having higher energy density per unit weight or unit volume than the electrochemical capacitor. However, the lithium ion battery is difficult to be commercialized due to low stability, short use time, long charge time, and small output density.

In recent times, since the electrochemical capacitor has lower energy density but better instant output and longer lifespan than the lithium ion battery, the electrochemical capacitor is being rapidly risen as a new alternative that can substitute for the lithium ion battery.

In particular, a lithium ion capacitor among the electrochemical capacitors can increase energy density without reduction in output in comparison with other electrochemical capacitors, attracting many attentions.

The lithium ion capacitor mainly uses graphite having a high discharge capacity as an anode. Here, the graphite may be manufactured in a slurry state and applied onto a current collector to be used as an anode. At this time, an anode active material layer is repeatedly expanded and contracted by doping and undoping of the lithium due to charge and discharge, decreasing cycle characteristics of the lithium ion capacitor.

In addition, since the anode active material layer is doped with lithium ions so that a potential of the anode active material layer approaches 0.1V with respect of lithium, electrolyte may be decomposed at a surface of the anode active material layer and a solid electrolyte interface (SEI) film may be formed at a surface of the anode due to reaction between lithium impregnated in the graphite and the electrolyte. A quantity of electric charge consumed to form the SEI film is an irreversible capacity, which cannot reversibly react upon discharge. That is, the irreversible capacity may be generated due to formation of the SEI film to decrease a discharge capacity.

In addition, a thickness or a boundary surface state of the SEI film may be varied depending on kinds of electrolytes to affect characteristics of the lithium ion capacitor. In particular, in fields of requiring high output characteristics, since the SEI film may act as a cause of increasing resistance, a reversible capacity of the lithium may be reduced during charge/discharge and cycle deterioration may occur.

Therefore, while the lithium ion capacitor can satisfy both output density and energy density to be used as a new electrochemical energy device, various problems such as low stability, bad high-current characteristics and low cycle characteristics are still remained.

### SUMMARY OF THE INVENTION

The present invention has been invented in order to overcome the above-described problems and it is, therefore, an object of the present invention to provide a lithium ion capacitor including a lithium oxide layer having a spinel structure on an active material layer to improve stability, high current characteristics and cycle characteristics, and a method of manufacturing the same.

In accordance with one aspect of the present invention to achieve the object, there is provided a lithium ion capacitor including cathodes and anodes alternately disposed with the separators interposed therebetween, wherein the anode comprises an anode current collector, a first anode active material layer disposed on at least one surface of the anode current collector, and a second anode active material layer disposed on the first anode active material layer and formed of a lithium oxide layer having a spinel structure.

Here, the lithium oxide layer having a spinel structure may be formed of Li₄Ti₅O₁₂.

In addition, the second anode active material layer may have a thickness of 5 to 50 nm.

Further, the first anode active material layer may include a carbon material to which lithium ions are adsorbed.

Furthermore, the first and second anode active material layers may have an area corresponding to each other and overlap each other.

In addition, the lithium ion capacitor may further include electrolyte in which the electrode cell is immersed; and a housing in which the electrode cell immersed in the electrolyte is sealed.

In accordance with another aspect of the present invention to achieve the object, there is provided a method of manufacturing a lithium ion capacitor including: forming a first anode active material layer on at least one surface of an anode current collector; pre-doping lithium ions on the first anode active material layer; forming a second anode active material layer formed of a lithium oxide layer having a spinel structure on the first anode active material layer, to which the lithium ions are adsorbed, to form an anode; and alternately disposing the anode and a cathode with a separator interposed therebetween to form an electrode cell.

Here, the lithium oxide layer having a spinel structure may be formed of Li₄Ti₅O₁₂.

In addition, the second anode active material layer may be formed to a thickness of 5 to 50 nm.

Further, pre-doping the lithium ions on the first anode active material layer may be performed by short circuit between the first anode active material layer and a lithium supply source.

Furthermore, the lithium supply source may include any one of a lithium metal or a lithium alloy.

In addition, the second anode active material layer formed of the lithium oxide layer having a spinel structure may be formed by applying slurry including a lithium oxide material having a spinel structure on the first anode active material layer.

Further, the second anode active material layer formed of the lithium oxide layer having a spinel structure may be formed through a deposition method.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is an exploded perspective view of a lithium ion capacitor in accordance with a first exemplary embodiment of the present invention;

FIG. 2 is an assembled perspective view of the lithium ion capacitor shown in FIG. 1;

FIG. 3 is a cross-sectional view of a device of an electrode cell of FIG. 1;

FIG. 4 is a cross-sectional view of an anode shown in FIG. 3; and

FIGS. 5 to 7 are cross-sectional views for explaining a process of manufacturing a lithium ion capacitor in accordance with a second exemplary embodiment of the present invention.

### DETAILED DESCRIPTION OF THE PREFERABLE EMBODIMENTS

Hereinafter, embodiments of the present invention for a lithium ion capacitor will be described in detail with reference to the accompanying drawings. The following embodiments are provided as examples to fully convey the spirit of the invention to those skilled in the art.

Therefore, the present invention should not be construed as limited to the embodiments set forth herein and may be embodied in different forms. And, the size and the thickness of an apparatus may be overdrawn in the drawings for the convenience of explanation. The same components are represented by the same reference numerals hereinafter.

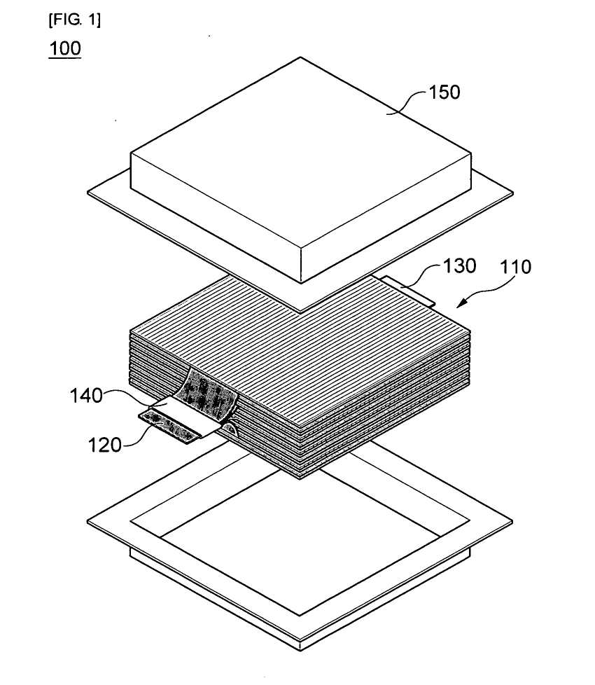

FIG. 1 is an exploded perspective view of a lithium ion capacitor in accordance with a first exemplary embodiment of the present invention.

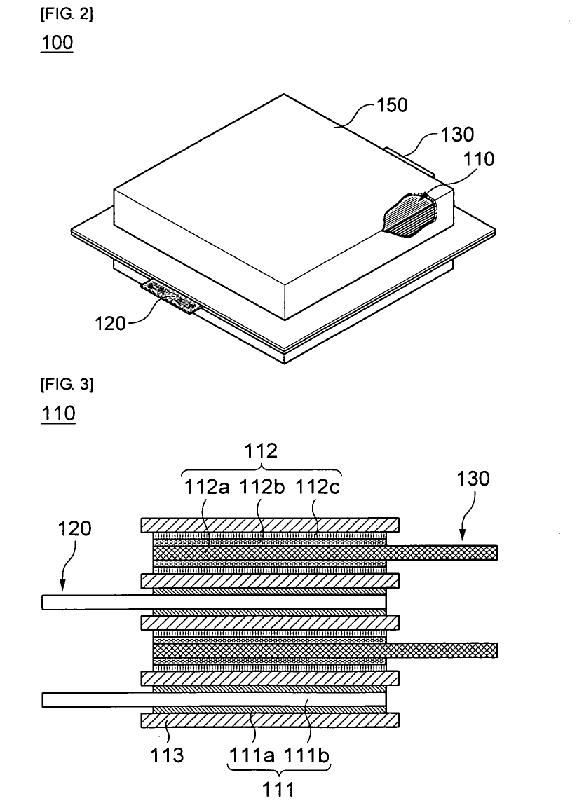

FIG. 2 is an assembled perspective view of the lithium ion capacitor shown in FIG. 1.

FIG. 3 is a cross-sectional view of a device of an electrode cell of FIG. 1.

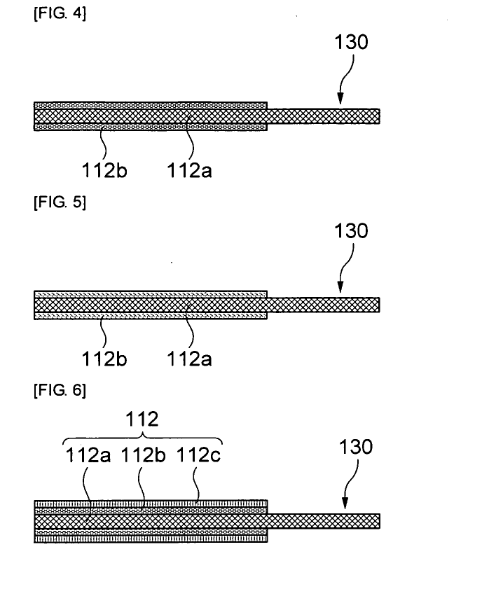

FIG. 4 is a cross-sectional view of an anode shown in FIG. 3.

Referring to FIGS. 1 to 4, a lithium ion capacitor 100 in accordance with a first exemplary embodiment of the present invention may include a housing 150, an electrode cell sealed by the housing 150, and an electrolyte in which the electrode cell 110 is immersed.

Here, the lithium ion capacitor 100 may be referred to as a supercapacitor, an ultracapacitor, or the like.

The electrode cell 110 may include cathodes 111 and anodes 112, which are alternately disposed with separators 113 interposed therebetween. At this time, the cathodes 111 and the anodes 112 may partially overlap each other. Here, in the electrochemical capacitor, i.e., the lithium ion capacitor, the cathode 111 may be referred to as a positive electrode. In addition, the anode 112 may be referred to as a negative electrode.

The anode 112 may include an anode current collector 112a, and first and second anode active material layers 112b and 112c sequentially disposed on at least one surface of the anode current collector 112a.

The anode current collector 112a may be formed of a metal, for example, one of copper, nickel and stainless steel, or an alloy of two or more. The anode current collector 112a may have a thin film shape, or may include a plurality of through-holes to effectively move ions and perform a uniform doping process.

The first anode active material layer 112b may be formed of a carbon material that can reversibly dope and undope lithium ions, for example, any one or mixed two or more of natural graphite, synthetic graphite, graphitized carbon fiber, non-graphitized carbon, and carbon nanotube.

In addition, the first anode active material layer 112b may further include a binder. Here, the binder may be formed of a material, for example, one or two or more selected from fluoride-based resin such as polytetrafluoroethylene (PTFE), polyvinylidene fluoride (PVdF), and so on, thermosetting resin such as polyimide, polyamidoimide, polyethylene (PE), polypropylene (PP), and so on, cellulose-based resin such as carboximethyl cellulose (CMC), and so on, rubber-based resin such as stylenebutadiene rubber (SBR), and so on, ethylenepropylenediene monomer (EPDM), polydimethylsiloxane (PDMS), polyvinyl pyrrolidone (PVP), and so on. Further, the anode active material layer 112b may further include a conductive material, for example, carbon black, solvent, and so on.

Since the first anode active material layer 112b is pre-doped with lithium ions so that a potential of the first active material layer 112b can approach 0V with respect to lithium, it is possible to increase energy density of the lithium ion capacitor and improve charge/discharge cycle reliability. At this time, the potential of the first anode active material layer 112b may be variously varied according to applied products through control of a pre-doping process of the lithium ion.

The second anode active material layer 112c is disposed on the first anode active material layer 112b. That is, the first and second anode active material layers 112b and 112c may have an area corresponding to each other and may overlap each other. The second anode active material layer 112c functions to prevent decomposition of electrolyte, suppress growth of a resin phase formed upon charges and discharges repeated on the surface of the first anode active material layer 112b, and form a solid electrolyte interface (SEI) film to a minimal thickness only. That is, due to formation of the second anode active material layer 112c, a formation amount and thickness of the SEI film on the surface of the first anode active material layer 112b may be decreased.

As the formation amount and thickness of the SEI film is decreased, it is possible to reduce an irreversible capacity and a discharge capacity upon initial charge/discharge. In addition, in fields requiring high output characteristics, increase in resistance due to the SEI film can be reduced, and thus, it is possible to accomplish high current characteristics that cannot be used in the lithium ion battery but can be applied to the high output application fields.

For this, the second anode active material layer 112c may be formed of a material having a higher potential than that of the first anode active material layer 112b, for example, 1.55V. For example, the second anode active material layer 112c may be formed of a lithium oxide layer having a spinel structure, for example, Li₄Ti₅O₁₂.

In addition, since the second anode active material layer 112c is formed of a lithium oxide layer having a spinel structure, it is possible to prevent expansion and contraction of the first anode active material layer 112b due to charges and discharges. Therefore, the second anode active material layer 112c can prevent deformation of the anode active material due to charges and discharges to accomplish stability of the lithium ion capacitor 100.

In particular, Li₄Ti₅O₁₂ among the lithium oxide layer having a spinel structure can directly participate in oxidation-reduction reaction of the lithium ion capacitor 100 to increase capacity of the lithium ion capacity.

The second anode active material layer 112c may be formed to a thickness of 5 to 50 nm in consideration of electrical conductivity and mechanical characteristics. Here, when the thickness of the second anode active material layer 112c is smaller than 5 nm, mechanical strength that can suppress expansion of the first anode active material layer 112b cannot be obtained. In addition, when the thickness of the second anode active material layer 112c exceeds 50 nm, the capacity of the lithium ion capacitor 100 may be decreased due to reduction in electrical conductivity.

Therefore, the first anode active material layer 112b may be formed of a carbon material pre-doped with lithium ions to improve discharge capacity and energy density. In addition, the second anode active material layer 112c may function to prevent increase in formation amount and thickness of the SEI film and prevent reduction in initial irreversible capacity, reduction in discharge capacity and decrease in high current characteristics of the lithium ion capacitor 100. Further, the second anode active material layer 112c may function to suppress deformation of the first anode active material layer 112b upon charges and discharges to obtain lifespan characteristics and stability of a charge/discharge cycle.

Furthermore, the anode 112 may include an anode terminal 130 to be connected to an external power supply. The anode terminal 130 may extend from the anode current collector 112a. Here, since the anode terminal 130 may extend from the respective anode current collectors 112a to be stacked in plural, the stacked anode terminals 130 may be integrally formed by ultrasonic bonding to be easily connected to the external power source. In addition, the anode terminal 130 may include a separate external terminal, and the anode terminal 130 may be connected to the external terminal by bonding or welding.

The cathode 111 may include a cathode current collector 111a, and a cathode active material layer 111b disposed on at least one surface of the cathode current collector 111a.

Here, the cathode current collector 111a may be formed of a metal, for example, any one of aluminum, stainless steel, copper, nickel, titanium, tantalum and niobium, or an alloy thereof. The cathode current collector 111a may have a thin film or mesh shape.

In addition, the cathode active material layer 111b may include a carbon material to which ions can be reversibly doped and undoped, i.e., activated carbon. Further, the cathode active material layer 111b may further include a binder. Here, the binder may be formed of a material, for example, one or two or more selected from fluoride-based resin such as polytetrafluoroethylene (PTFE), polyvinylidene fluoride (PVdF), and so on, thermosetting resin such as polyimide, polyamidoimide, polyethylene (PE), polypropylene (PP), and so on, cellulose-based resin such as carboximethyl cellulose (CMC), and so on, rubber-based resin such as stylenebutadiene rubber (SBR), and so on, ethylenepropylenediene monomer (EPDM), polydimethylsiloxane (PDMS), polyvinyl pyrrolidone (PVP), and so on. Further, the cathode active material layer 111b may further include a conductive material, for example, carbon black, solvent, and so on.

However, in this embodiment of the present invention, the material of the cathode active material layer 111b is not limited thereto.

Here, the cathode 111 may include a cathode terminal 120 to be connected to an external power source. The cathode terminal 120 may be formed by bonding a separate terminal thereto, or may extend from the cathode current collector 111a of the cathode 111.

In addition, the cathode terminal 120 and the anode terminal 130 may include insulating members installed at portions of upper and lower parts thereof, respectively. The insulating members 140 may function to secure insulation between the cathode terminal 120, the anode terminal 130 and the housing 150, which is to be described.

The separator 113 may function to electrically separate the cathode 111 and the anode 112 from each other. While the separator 113 may be formed of paper or non-woven fabric, kinds of the separator in the embodiment of the present invention is not limited thereto.

While the electrode cell 110 of this embodiment of the present invention has been shown and described as being formed in a pouch type, the electrode cell 110 is not limited thereto but may be formed in a wound type in which the cathode 111, the anode 112 and the separator 113 are wound in a roll shape.

The electrode cell 110 is immersed in the electrolyte. At this time, the cathode active material layer 111b of the cathode layer 111, the first and second anode active material layers 112b and 112c of the anode 112, and the separator 113 may be immersed in the electrolyte.

The electrolyte may function as a medium that can move lithium ions, and may include an electrolytic material and solution. Here, the electrolytic material may include any one lithium salt of LiPF₆, LiBF₄ and LiClO₄. Here, the lithium salt may function as a source of lithium ions doped to the anode upon charge of the lithium ion capacitor. In addition, a material used as solvent in the electrolyte may be any one or mixed solvent of two or more selected from propylene carbonate, ethylene carbonate, diethyl carbonate, dimethyl carbonate, and ethyl methyl carbonate.

The electrode cell 110 immersed in the electrolyte may be sealed by the housing 150. Here, while the housing 150 may be formed by hot-melting two sheets of laminated films, the housing 150 of the embodiment of the present invention is not limited thereto but may be formed of a metal can.

A process of manufacturing a lithium ion capacitor in accordance with a second exemplary embodiment of the present invention will be described below.

Referring to FIG. 5, in order to manufacture a lithium ion capacitor in accordance with a second exemplary embodiment of the present invention, first, first anode active material layers 112b are formed on both surfaces of an anode current collector 112a. Here, the anode current collector 112a may be a metal thin film or a metal mesh. At this time, the anode current collector 112a may be formed of a material, for example, any one or an alloy of two or more selected from copper, nickel and stainless steel.

A first anode active material layer 112b may be formed by mixing a carbon material to which lithium ions can be reversibly doped and undoped, a binder, a conductive material, and solvent to form slurry, and then, applying the slurry on the anode current collector 112a.

Here, the carbon material may be a material, for example, any one or mixed two or more of natural graphite, synthetic graphite, graphitized carbon fiber, non-graphitized carbon, and carbon nanotube.

In addition, the binder may be formed of a material, for example, one or two or more selected from fluoride-based resin such as polytetrafluoroethylene (PTFE), polyvinylidene fluoride (PVdF), and so on, thermosetting resin such as polyimide, polyamidoimide, polyethylene (PE), polypropylene (PP), and so on, cellulose-based resin such as carboximethyl cellulose (CMC), and so on, rubber-based resin such as stylenebutadiene rubber (SBR), and so on, ethylenepropylenediene monomer (EPDM), polydimethylsiloxane (PDMS), polyvinyl pyrrolidone (PVP), and so on.

Further, the conductive material may be, for example, a carbon black.

After forming the first anode active material layer 112b, a pre-doping process of the lithium is performed to the first anode active material layer 112b.

Here, the pre-doping process of the lithium ion may be performed by electrical short circuit of the first anode active material layer 112b and the lithium supply source. At this time, when the first anode active material layer 112b and the lithium supply source are short-circuited, due to a potential difference between the first anode active material layer 112b and the lithium supply source, the lithium ions contained in the lithium supply source can be doped to the first anode active material layer 112b. Here, the lithium supply source may be a compound, for example, any one of a lithium metal or a lithium alloy.

Referring to FIG. 6, after performing the pre-doping process of the lithium ion to the first anode active material layer 112b, a second anode active material layer 112c is formed on the first anode active material layer 112b.

The second anode active material layer 112c may be formed of a lithium oxide having a spinel structure, for example, Li₄Ti₅O₁₂, to reduce a formation amount and thickness of the SEI film on the surface of the first anode active material layer 112b and prevent deformation of the first anode active material layer 112b.

The second anode active material layer 112c may be formed by mixing the lithium oxide having a spinet structure and the binder to manufacture slurry, and applying the slurry onto the first anode active material layer 112b. Or, the second anode active material layer 112c may be formed by a physical vapor deposition method.

The second anode active material layer 112c may be formed to a thickness of 5 to 50 nm in consideration of electrical conductivity and mechanical characteristics. At this time, the anode 112 may include an anode terminal 130 extending from the anode current collector 112a.

Therefore, the anode 112 including the first and second anode active material layers 112b and 112c, which are sequentially applied on the anode current collector 112a, may be formed.

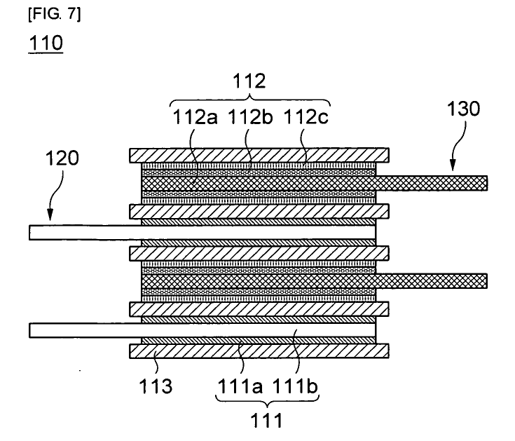

Referring to FIG. 7, after forming the anode 112, the anodes 112 and the cathodes 111 are alternately disposed with the separators 113 interposed therebetween to form the electrode cell 110.

Next, the anode terminals 130 laminated in plural and the cathode terminals 120 laminated in plural are bonded and integrally formed with each other during formation of the electrode cell 110. Here, the melting process may be performed by ultrasonic welding, laser welding, spot welding, and so on, and the embodiment of the present invention is not limited thereto. In addition, the bonded anode terminals 130 and cathode terminals 120 may be separately connected to external terminals, respectively.

After forming the electrode cell 110, while not shown, the electrode cell 110 and the electrolyte may be sealed by the housing 150 to form the lithium ion capacity 100.

Specifically describing the sealing process of the electrode cell 110, first, two sheets of laminated films 160 are provided to sandwich the electrode cell 110. Next, the two laminated films are thermal-bonded so that the electrode cell can be contained in the housing 150. At this time, the bonded cathode terminals 120 and anode terminals 130 are exposed from the housing to be electrically connected to the external power supply.

Here, the thermal bonding process is performed along an edge of the two laminated films, but remaining a gap through which electrolyte is inserted into the electrode cell 110 interposed between the two laminated films. After inserting the electrolyte through the gap, the gap may be vacuum-sealed to form the lithium ion capacitor 100.

Here, while the housing 150 has been described as being formed using the laminated films, the housing is not limited thereto but may use a metal can.

Therefore, as described in the embodiment of the present invention, the lithium oxide layer having a spinel structure may be formed on the active material layer formed of a carbon material to form the lithium ion capacitor capable of improving stability, high current characteristics and cycle characteristics.

As can be seen from the foregoing, the lithium ion capacitor includes the lithium oxide layer having a spinel structure on the active material layer formed of a carbon material to prevent direct contact between the active material layer formed of a carbon material and the electrolyte, preventing decomposition of the electrolyte and securing stability of the lithium ion capacity.

In addition, the lithium oxide layer having a spinel structure can prevent expansion and contraction of the active material layer due to charges and discharges, improving cycle characteristics of the lithium ion capacitor.

Further, the lithium oxide layer having a spinel structure can reduce a formation amount and thickness of the SEI film on the surface of the active material layer formed of a carbon material to reduce resistance of the lithium ion capacitor, securing high current characteristics that can be applied to high output application fields.

Furthermore, the lithium oxide layer having a spinel structure can directly participate in oxidation-reduction reaction to prevent decrease in battery capacity.

As described above, although the preferable embodiments of the present invention have been shown and described, it will be appreciated by those skilled in the art that substitutions, modifications and variations may be made in these embodiments without departing from the principles and spirit of the general inventive concept, the scope of which is defined in the appended claims and their equivalents.

What is claimed is:

1. A lithium ion capacitor including cathodes and anodes alternately disposed with the separators interposed therebetween,
wherein the anode comprises an anode current collector, a first anode active material layer disposed on at least one surface of the anode current collector, and a second anode active material layer disposed on the first anode active material layer and formed of a lithium oxide layer having a spinel structure.

2. The lithium ion capacitor according to claim 1, wherein the lithium oxide layer having a spinel structure is formed of Li₄Ti₅O₁₂.

3. The lithium ion capacitor according to claim 1, wherein the second anode active material layer has a thickness of 5 to 50 nm.

4. The lithium ion capacitor according to claim 1, wherein the first anode active material layer comprises a carbon material to which lithium ions are adsorbed.

5. The lithium ion capacitor according to claim 1, wherein the first and second anode active material layers have an area corresponding to each other and overlap each other.

6. The lithium ion capacitor according to claim 1, further comprising:
electrolyte in which the electrode cell is immersed; and
a housing in which the electrode cell immersed in the electrolyte is sealed.

7. A method of manufacturing a lithium ion capacitor comprising:
forming a first anode active material layer on at least one surface of an anode current collector;
pre-doping lithium ions on the first anode active material layer;
forming a second anode active material layer formed of a lithium oxide layer having a spinel structure on the first anode active material layer, to which the lithium ions are adsorbed, to form an anode; and
alternately disposing the anode and a cathode with a separator interposed therebetween to form an electrode cell.

8. The method of manufacturing a lithium ion capacitor according to claim 7, wherein the lithium oxide layer having a spinel structure is formed of Li₄Ti₅O₁₂.

9. The method of manufacturing a lithium ion capacitor according to claim 7, wherein the second anode active material layer is formed to a thickness of 5 to 50 nm.

10. The method of manufacturing a lithium ion capacitor according to claim 7, wherein pre-doping the lithium ions on the first anode active material layer is performed by short circuit between the first anode active material layer and a lithium supply source.

11. The method of manufacturing a lithium ion capacitor according to claim 10, wherein the lithium supply source comprises any one of a lithium metal or a lithium alloy.

12. The method of manufacturing a lithium ion capacitor according to claim 7, wherein the second anode active material layer formed of the lithium oxide layer having a spinel structure is formed by applying slurry including a lithium oxide material having a spinel structure on the first anode active material layer.

13. The method of manufacturing a lithium ion capacitor according to claim 7, wherein the second anode active material layer formed of the lithium oxide layer having a spinel structure is formed through a deposition method.
